(19) United States
(12) Patent Application Publication
(10) Pub. No.: US 2024/0245041 A1
(43) Pub. Date: Jul. 25, 2024

(54) FISHING LURE WITH HYDROFOIL FLARES, CYLINDRICAL HINGES, AND HOOK CAVITY

(71) Applicant: Chong Vang, Sacramento, CA (US)

(72) Inventor: Chong Vang, Sacramento, CA (US)

(21) Appl. No.: 18/098,815

(22) Filed: Jan. 19, 2023

(51) Int. Cl. A01K 85/00; A01K 85/01; A01K 85/18

(52) U.S. Cl. CPC A01K 85/1813; A01K 85/017; A01K 85/018; A01K 85/18

(57) ABSTRACT

Fishing lure with hydrofoil flares, cylindrical hinges, and hook cavity is a special fishing lure that swims like a real fish when it is travelling through the water. Fishing lure with hydrofoil flares, cylindrical hinges, and hook cavity has two hydrofoil flares and two cylindrical hinges that cause the fishing lure to appear to be swimming. Fishing lure with hydrofoil flares, cylindrical hinges, and hook cavity also has a special hook cavity with a hook puncture tab and a hook stop tab that securely holds a fishing hook inside the fishing lure. Fishing lure with hydrofoil flares, cylindrical hinges, and hook cavity also has a weight cavity, rattle cavity, glow stick cavity, and a scent cavity to help attract real fish to the fishing lure.

### BACKGROUND OF THE INVENTION

### 1. Field of the Invention

This invention relates to fishing lures and in particular to: 1) flexible fishing lures with special flares and special cylindrical hinges that cause the fishing lure to appear like it is swimming in the water; 2) fishing lures with a special hook cavity with a special hook puncture tab and special hook stop tab to allow for superior insertion and placement of a fishing hook within the fishing lure; and 3) fishing lures with a weight cavity, a rattle cavity, two glow stick cavities, and a scent cavity to provide superior attraction properties to successfully attract fish to the fishing lure.

### 2. Description of Related Art

There are many fishing lures in the prior art. However, there are none with the special hydrofoil flares and special cylindrical hinges as shown and described below. Also, there are no fishing lures with the special hook cavity as shown and described below. Also, there are no fishing lures with the weight cavity, rattle cavity, two glow stick cavities, and scent cavity as shown and described below.

### BRIEF SUMMARY OF THE INVENTION

It is an aspect of fishing lure with hydrofoil flares, cylindrical hinges, and hook cavity to be an oblong flexible member which looks like a fish or bait fish.

It is an aspect of fishing lure with hydrofoil flares, cylindrical hinges, and hook cavity to appear as if it were swimming like a fish when the lure is reeled in by the fisherman and traveling through the water.

It is an aspect of fishing lure with hydrofoil flares, cylindrical hinges, and hook cavity to have a left hydrofoil flare or fin that helps create the swimming effect as the lure is traveling through water.

It is an aspect of fishing lure with hydrofoil flares, cylindrical hinges, and hook cavity to have a right hydrofoil flare or fin that helps create the swimming effect as the lure is traveling through water.

It is an aspect of fishing lure with hydrofoil flares, cylindrical hinges, and hook cavity to have a left cylindrical hinge that helps create the swimming effect as the lure is traveling through water.

It is an aspect of fishing lure with hydrofoil flares, cylindrical hinges, and hook cavity to have a right cylindrical hinge that helps create the swimming effect as the lure is traveling through water.

It is an aspect of fishing lure with hydrofoil flares, cylindrical hinges, and hook cavity to have a hook cavity with a special puncture tab and a special stop tab to ensure optimum and proper hook attachment to the lure.

It is an aspect of fishing lure with hydrofoil flares, cylindrical hinges, and hook cavity to have a weight cavity which is used to reversibly secure a weight to the fishing lure.

It is an aspect of fishing lure with hydrofoil flares, cylindrical hinges, and hook cavity to have a rattle cavity which is used to reversibly secure a rattle to the fishing lure.

It is an aspect of fishing lure with hydrofoil flares, cylindrical hinges, and hook cavity to have a first glow stick cavity which is used to reversibly secure a first glow stick to the fishing lure.

It is an aspect of fishing lure with hydrofoil flares, cylindrical hinges, and hook cavity to have a second glow stick cavity which is used to reversibly secure a second glow stick to the fishing lure.

It is an aspect of fishing lure with hydrofoil flares, cylindrical hinges, and hook cavity to have a scent cavity which is used to receive and hold a scent oil, liquid, or gel to the fishing lure.

### BRIEF DESCRIPTION OF THE DRAWINGS

FIG. 1 is a top left perspective view of fishing lure with hydrofoil flares, cylindrical hinges, and hook cavity.

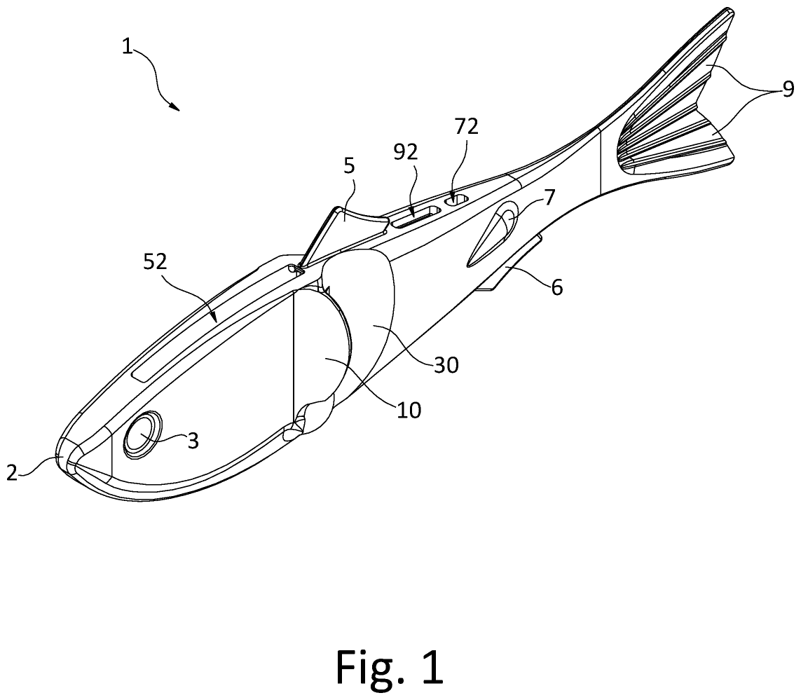

FIG. 2 is a top right perspective view of fishing lure with hydrofoil flares, cylindrical hinges, and hook cavity.

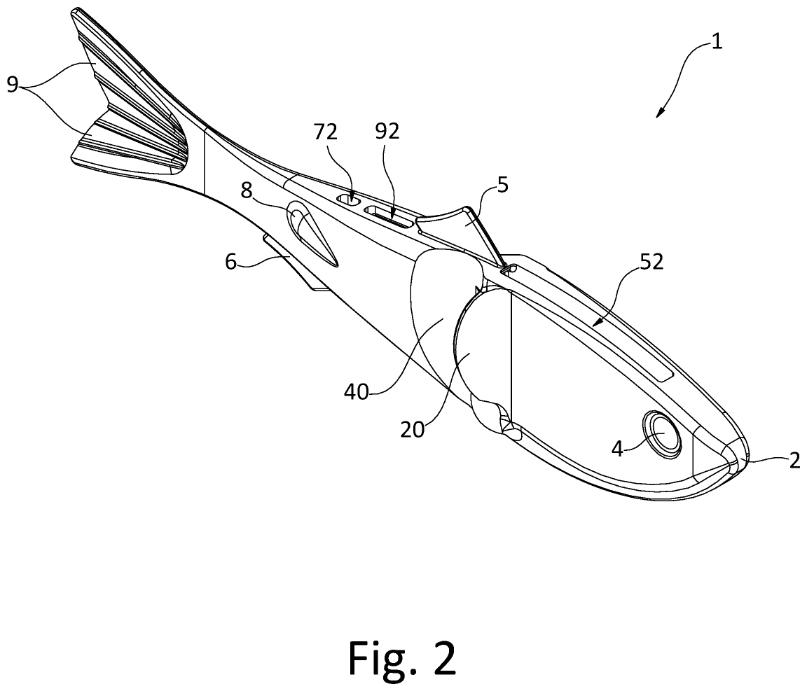

FIG. 3 is a front elevation view of fishing lure with hydrofoil flares, cylindrical hinges, and hook cavity.

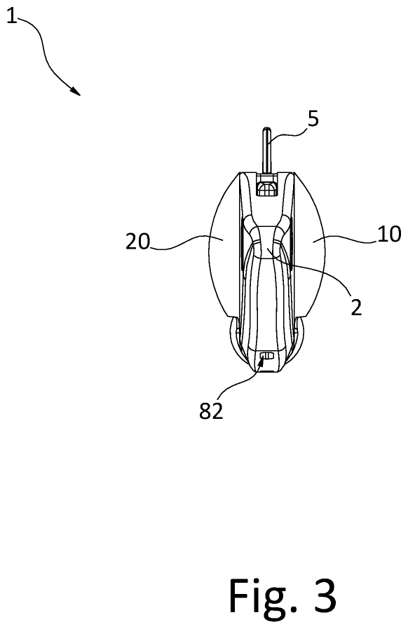

FIG. 4 is a left side elevation view of fishing lure with hydrofoil flares, cylindrical hinges, and hook cavity.

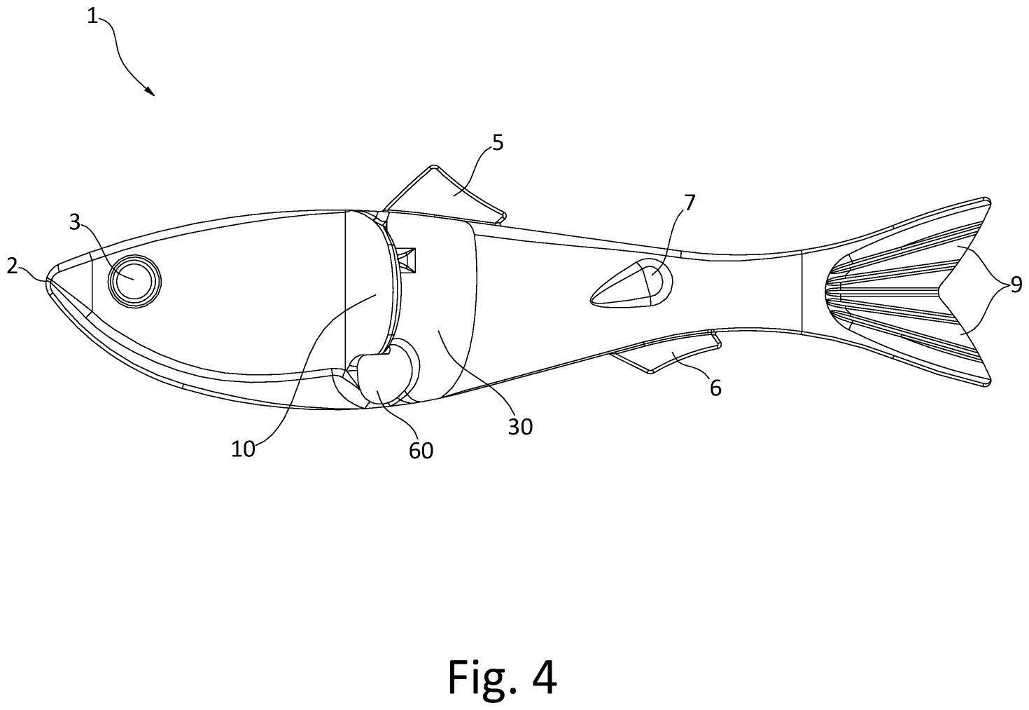

FIG. 5 is a right side elevation view of fishing lure with hydrofoil flares, cylindrical hinges, and hook cavity.

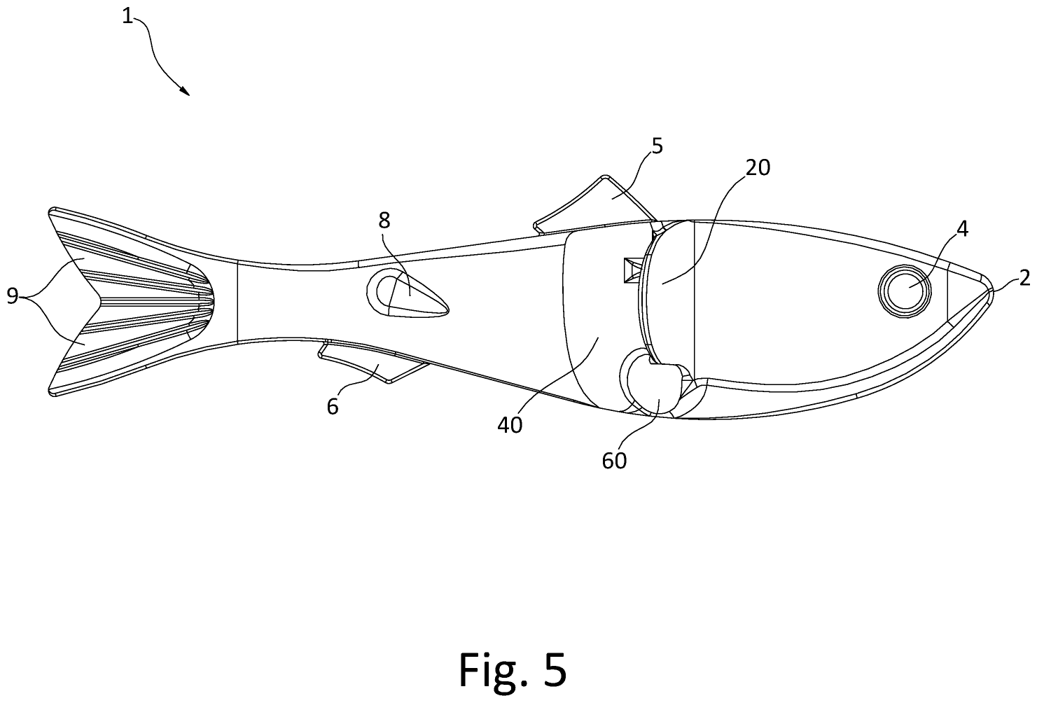

FIG. 6 is a rear elevation view of fishing lure with hydrofoil flares, cylindrical hinges, and hook cavity.

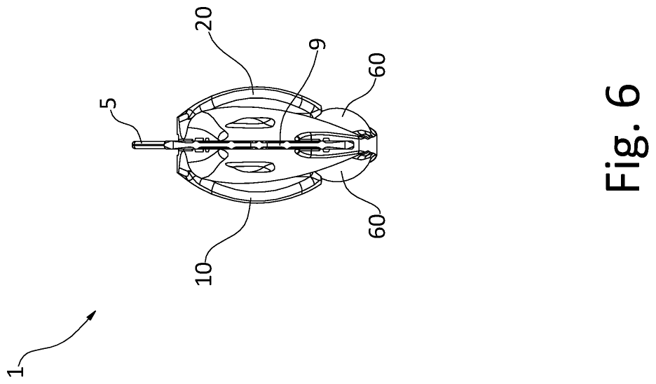

FIG. 7 is a bottom plan view of fishing lure with hydrofoil flares, cylindrical hinges, and hook cavity.

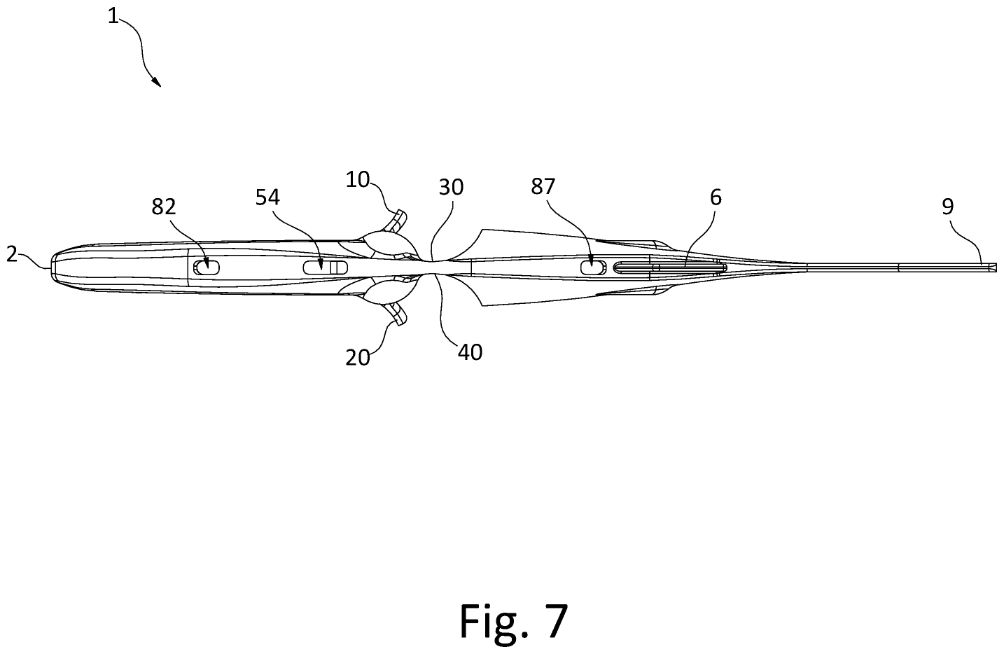

FIG. 8 is a top plan view of fishing lure with hydrofoil flares, cylindrical hinges, and hook cavity.

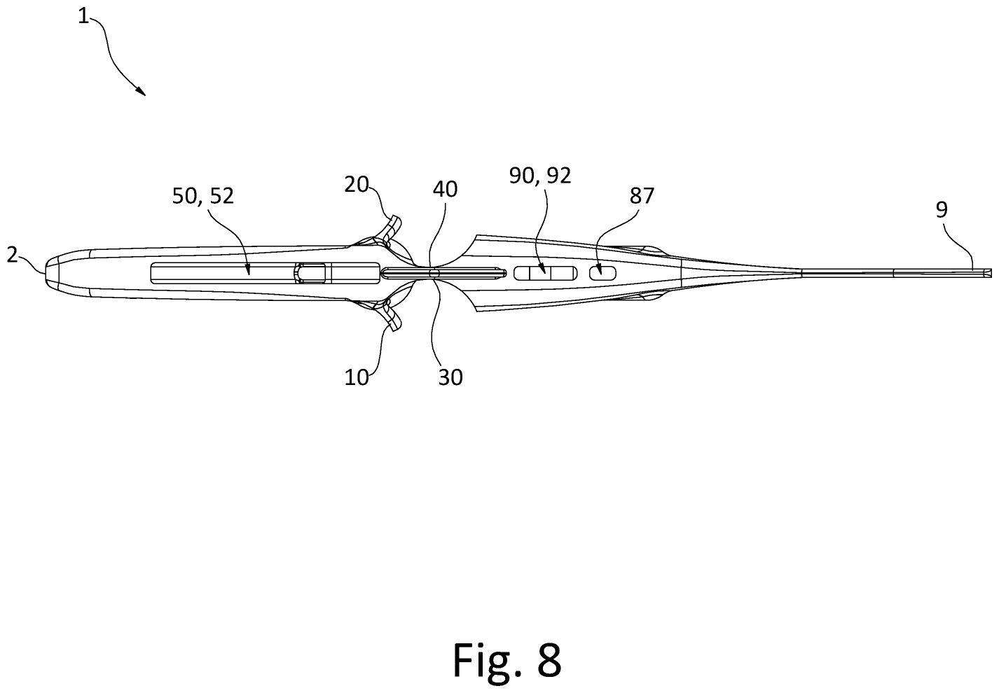

FIG. 9 is a top plan view of fishing lure with hydrofoil flares, cylindrical hinges, and hook cavity defining a cross sectional plane along with a cross section view taken from the defined cross sectional plane.

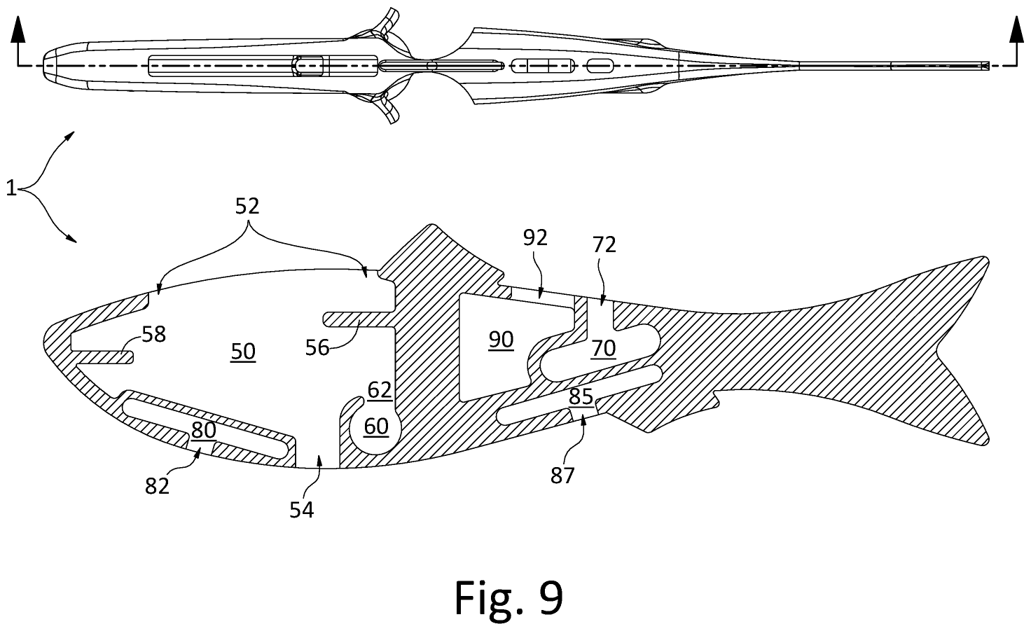

FIG. 10 is a top plan view of fishing lure with hydrofoil flares, cylindrical hinges, and hook cavity defining a cross sectional plane along with a cross section view taken from the defined cross sectional plane, wherein a hook is installed in the hook cavity in both views.

FIG. 11 is a top plan view of fishing lure with hydrofoil flares, cylindrical hinges, and hook cavity defining a cross sectional plane along with a cross section view taken from the defined cross sectional plane, wherein a hook, a weight, a rattle, a first glow stick, and a second glow stick are installed in the hook cavity, weight cavity, rattle cavity, first glow stick cavity, and second glow stick cavity respectively in both views.

FIG. 12 is a top plan view and a top left perspective view of fishing lure with hydrofoil flares, cylindrical hinges, and hook cavity depicting how the hydrofoil flares and cylindrical hinges cause the fishing lure to flex as the fishing lure glides through the water.

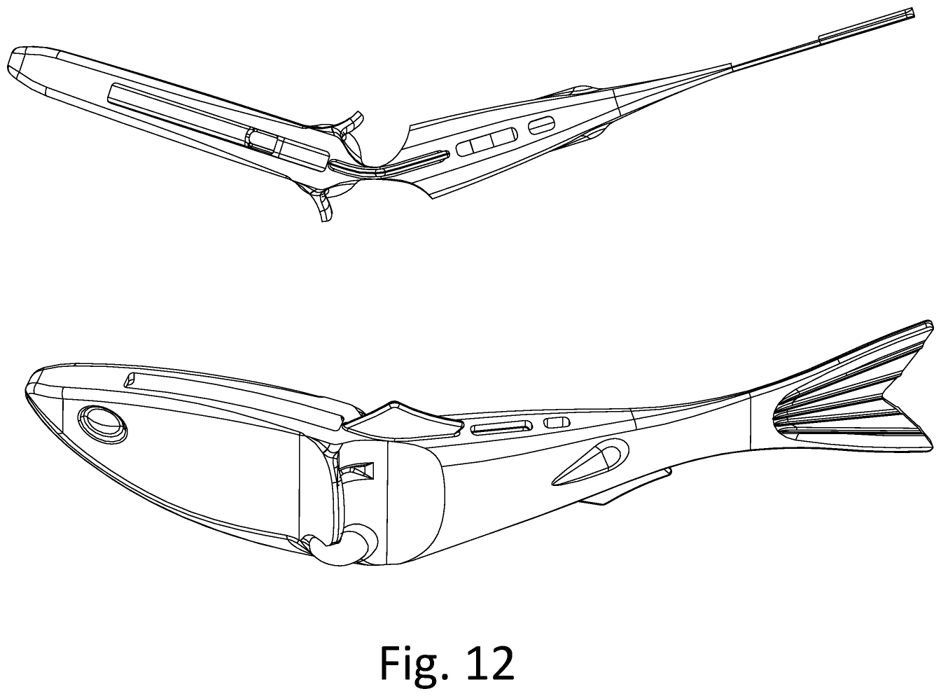

FIG. 13 is a series of three top plan views of fishing lure with hydrofoil flares, cylindrical hinges, and hook cavity depicting how the hydrofoil flares and cylindrical hinges cause the fishing lure to swim as the fishing lure glides through the water.

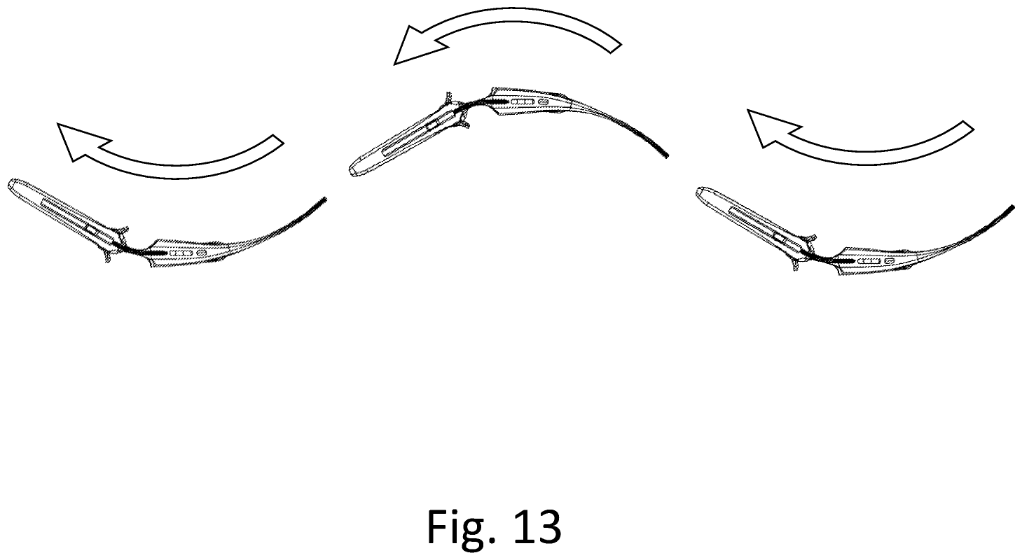

DEFINITION LIST

| Term | Definition |
|---|---|
| 1 | Fishing Lure with Hydrofoil Flares, Cylindrical Hinges, and |
| | Hook Cavity |
| 2 | Nose |
| 3 | Left Eye |
| 4 | Right Eye |
| 5 | Dorsal Fin |
| 6 | Anal Fin |
| 7 | Left Adipose Fin |
| 8 | Right Adipose Fin |
| 9 | Tail Fin |
| 10 | Left Hydrofoil Flare |
| 20 | Right Hydrofoil Flare |
| 30 | Left Cylindrical Hinge |
| 40 | Right Cylindrical Hinge |
| 50 | Hook Cavity |
| 52 | Hook Exposure Port |
| 54 | Hook Cavity Drain Port |
| 56 | Hook Puncture Tab |
| 58 | Hook Stop Tab |
| 60 | Weight Cavity |
| 62 | Weight Insertion Port |
| 70 | Rattle Cavity |
| 72 | Rattle Insertion Port |
| 80 | First Glow Stick Cavity |
| 82 | First Glow Stick Insertion Port |
| 85 | Second Glow Stick Cavity |
| 87 | Second Glow Stick Insertion Port |
| 90 | Scent Cavity |
| 92 | Scent Cavity Insertion Port |
| 100 | Fishing Hook |
| 101 | Barbed Point on Fishing Hook |
| 102 | Eye on Fishing Hook |
| 103 | Weight |
| 104 | Rattle |
| 106 | First Glow Stick |
| 108 | Second Glow Stick |
| 110 | Scent |

### DETAILED DESCRIPTION OF THE INVENTION

Fishing lure with hydrofoil flares, cylindrical hinges, and hook cavity 1 is a fishing lure that looks like a fish or bait fish. Fishing lure with hydrofoil flares, cylindrical hinges, and hook cavity 1 is a long thin flexible member made of plastic or composite material. Fishing lure with hydrofoil flares, cylindrical hinges, and hook cavity 1 is a sheet of flexible material. In best mode, fishing lure with hydrofoil flares, cylindrical hinges, and hook cavity 1 is a molded product or a product made from a mold. Fishing lure with hydrofoil flares, cylindrical hinges, and hook cavity 1 has a left side, a right side, an upper edge, a lower edge, a front end, a rear end, a front section, a middle section, a tail section, a length, a width, an exterior surface, an interior, a longitudinal axis, and a latitudinal axis.

Fishing lure with hydrofoil flares, cylindrical hinges, and hook cavity 1 comprises: a nose 2; a left eye 3; a right eye 4; a dorsal fin 5; an anal fin 6; a left adipose fin 7; a right adipose fin 8; and a tail fin 9. Nose 2 is an oblong, rounded, projected member that looks like the nose of a real fish or bait fish. Nose 2 is on the front end of fishing lure with hydrofoil flares, cylindrical hinges, and hook cavity 1 and is the front most surface of fishing lure with hydrofoil flares, cylindrical hinges, and hook cavity 1. Nose 2 is the front of the lure. Left eye 3 is a circular concave or convex area on the exterior surface of fishing lure with hydrofoil flares, cylindrical hinges, and hook cavity 1 located on the left side of the front section of fishing lure with hydrofoil flares, cylindrical hinges, and hook cavity 1. Left eye 3 looks like a left eye on the fishing lure as depicted. Right eye 4 is a circular concave or convex area on the exterior surface of fishing lure with hydrofoil flares, cylindrical hinges, and hook cavity 1 located on the right side of the front section of fishing lure with hydrofoil flares, cylindrical hinges, and hook cavity 1. Right eye 4 looks like a right eye on the fishing lure as depicted. Dorsal fin 5 is a triangular shaped tab or appendage projecting upward from the exterior surface of fishing lure with hydrofoil flares, cylindrical hinges, and hook cavity 1 located on the upper edge of the middle section of fishing lure with hydrofoil flares, cylindrical hinges, and hook cavity 1. Dorsal fin 5 looks like a dorsal fin on the fishing lure as depicted. Anal fin 6 is a triangular or quadrilateral shaped tab or appendage projection downward from the exterior surface of fishing lure with hydrofoil flares, cylindrical hinges, and hook cavity 1 located on the lower edge of the tail section of fishing lure with hydrofoil flares, cylindrical hinges, and hook cavity 1. Anal fin 6 looks like an anal fin on the fishing lure as depicted. Left adipose fin 7 is a raised band or protrusion on the exterior surface of fishing lure with hydrofoil flares, cylindrical hinges, and hook cavity 1 located on the left side of the tail section of fishing lure with hydrofoil flares, cylindrical hinges, and hook cavity 1. Left adipose fin 7 looks like a left adipose fin on the fishing lure as depicted. Right adipose fin 8 is a raised band or protrusion on the exterior surface of fishing lure with hydrofoil flares, cylindrical hinges, and hook cavity 1 located on the right side of the tail section of fishing lure with hydrofoil flares, cylindrical hinges, and hook cavity 1. Right adipose fin 8 looks like a left adipose fin on the fishing lure as depicted. Tail fin 9 is an arrowhead shaped or arrow shaped tab or appendage on the rear end of fishing lure with hydrofoil flares, cylindrical hinges, and hook cavity 1. Tail fin 9 looks like a fork tail fin on the fishing lure as depicted. Tail fin 9 is the rear of the lure.

Fishing lure with hydrofoil flares, cylindrical hinges, and hook cavity 1 may be used in a lake, creek, river, pond, ocean, or any body of water with fish in it. Fishing lure with hydrofoil flares, cylindrical hinges, and hook cavity 1 is designed to look like it is swimming like a fish as the fisherman is reeling in the lure and the lure is traveling through water. Fishing lure with hydrofoil flares, cylindrical hinges, and hook cavity 1 is specially designed with certain surface features that cause the lure to swim or appear to be swimming like a fish. The left hydrofoil flare 10, right hydrofoil flare 20, left cylindrical hinge 30, and right cylindrical hinge 40 are what causes fishing lure with hydrofoil flares, cylindrical hinges, and hook cavity 1 to look like a real fishing swimming through the water.

Fishing lure with hydrofoil flares, cylindrical hinges, and hook cavity 1 comprises: a left hydrofoil flare 10 and a right hydrofoil flare 20. The shape and structure of left hydrofoil flare 10 and right hydrofoil flare 20 have been extensively tested and developed by the applicant to yield near perfect swimming action of the fishing lure which causes real fish to be attracted to the fishing lure in a substantial way thereby yielding a superior fishing lure for fisherman. Left hydrofoil flare 10 is symmetrical with right hydrofoil flare 20 where left hydrofoil flare 10 on the left side is located directly opposite and in alignment with right hydrofoil flare 20 on the right side.

Left hydrofoil flare 10 is a flexible vertical half-circle shaped or half-moon shaped tab or appendage projecting outward and rearward from the exterior surface of fishing lure with hydrofoil flares, cylindrical hinges, and hook cavity 1 on the left side and middle section of fishing lure with hydrofoil flares, cylindrical hinges, and hook cavity 1 as depicted. Left hydrofoil flare 10 is located in between the left eye 3 and the dorsal fin 7 of fishing lure with hydrofoil flares, cylindrical hinges, and hook cavity 1. Left hydrofoil flare 10 has a circular edge, straight edge, a longitudinal axis, and a latitudinal axis. The straight edge of left hydrofoil flare 10 is attached to the exterior surface of the left side of fishing lure with hydrofoil flares, cylindrical hinges, and hook cavity 1. The straight edge of left hydrofoil flare 10 is parallel with the longitudinal axis of left hydrofoil flare 10. The circular edge of left hydrofoil flare 10 is opposite the straight edge and projects outward and rearward as depicted. The longitudinal axis of left hydrofoil flare 10 is perpendicular to the longitudinal axis of fishing lure with hydrofoil flares, cylindrical hinges, and hook cavity 1. Thus, the longitudinal axis of fishing lure with hydrofoil flares, cylindrical hinges, and hook cavity 1 is essentially horizontal and the longitudinal axis of left hydrofoil flare 10 is essential vertical when fishing lure with hydrofoil flares, cylindrical hinges, and hook cavity 1 is swimming through the water. The latitudinal axis of left hydrofoil flare 10 is perpendicular to the longitudinal axis of left hydrofoil flare 10. The latitudinal axis of left hydrofoil flare 10 projects rearwards at an angle between 20-60 degrees from the longitudinal axis of fishing lure with hydrofoil flares, cylindrical hinges, and hook cavity 2. Together with right hydrofoil flare 20, left cylindrical hinge 30, and right cylindrical hinge 40, the left hydrofoil flare 10 helps cause fishing lure with hydrofoil flares, cylindrical hinges, and hook cavity 1 to look like a real fishing swimming in the water. In best mode, left hydrofoil flare 10 is integral with fishing lure with hydrofoil flares, cylindrical hinges, and hook cavity 1 and is molded in the same piece of material as fishing lure with hydrofoil flares, cylindrical hinges, and hook cavity 1.

Right hydrofoil flare 20 is a flexible vertical half-circle shaped or half-moon shaped tab or appendage projecting outward and rearward from the exterior surface of fishing lure with hydrofoil flares, cylindrical hinges, and hook cavity 1 on the right side and middle section of fishing lure with hydrofoil flares, cylindrical hinges, and hook cavity 1 as depicted. Right hydrofoil flare 20 is located in between the right eye 4 and the dorsal fin 7 of fishing lure with hydrofoil flares, cylindrical hinges, and hook cavity 1. Right hydrofoil flare 20 has a circular edge, straight edge, a longitudinal axis, and a latitudinal axis. The straight edge of right hydrofoil flare 20 is attached to the exterior surface of the right side of fishing lure with hydrofoil flares, cylindrical hinges, and hook cavity 1. The straight edge of right hydrofoil flare 20 is parallel with the longitudinal axis of right hydrofoil flare 20. The circular edge of left hydrofoil flare 10 is opposite the straight edge and projects outward and rearward as depicted. The longitudinal axis of right hydrofoil flare 20 is perpendicular to the longitudinal axis of fishing lure with hydrofoil flares, cylindrical hinges, and hook cavity 1. Thus, the longitudinal axis of fishing lure with hydrofoil flares, cylindrical hinges, and hook cavity 1 is essentially horizontal and the longitudinal axis of right hydrofoil flare 20 is essential vertical when fishing lure with hydrofoil flares, cylindrical hinges, and hook cavity 1 is swimming through the water. The latitudinal axis of right hydrofoil flare 20 is perpendicular to the longitudinal axis of right hydrofoil flare 20. The latitudinal axis of right hydrofoil flare 20 projects rearwards at an angle between 20-60 degrees from the longitudinal axis of fishing lure with hydrofoil flares, cylindrical hinges, and hook cavity 1. Together with left hydrofoil flare 10, left cylindrical hinge 30, and right cylindrical hinge 40, the right hydrofoil flare 20 helps cause fishing lure with hydrofoil flares, cylindrical hinges, and hook cavity 1 to look like a real fishing swimming in the water. In best mode, right hydrofoil flare 20 is integral with fishing lure with hydrofoil flares, cylindrical hinges, and hook cavity 1 and is molded in the same piece of material as fishing lure with hydrofoil flares, cylindrical hinges, and hook cavity 1.

Fishing lure with hydrofoil flares, cylindrical hinges, and hook cavity 1 comprises: a left cylindrical hinge 30 and a right cylindrical hinge 40. The shape and structure of left cylindrical hinge 30 and right cylindrical hinge 40 have been extensively tested and developed by the applicant to yield near perfect swimming action of the fishing lure which causes real fish to be attracted to the fishing lure in a substantial way thereby yielding a superior fishing lure for fisherman. The circular or cylindrical aspect of the hinges is crucial to the swimming action of the fishing lure. Left cylindrical hinge 30 is symmetrical with right cylindrical hinge 40 where left cylindrical hinge 30 on the left side is located directly opposite and in alignment with right cylindrical hinge 40 on the right side.

Left cylindrical hinge 30 is a cylindrical concave area in the exterior surface of fishing lure with hydrofoil flares, cylindrical hinges, and hook cavity 1 on the left side and middle section of fishing lure with hydrofoil flares, cylindrical hinges, and hook cavity 1 as depicted. Left cylindrical hinge 30 is a partial cylindrical shape. Left cylindrical hinge 30 has a radius, a width, a length, an upper edge, a lower edge, a leading edge, a trailing edge, a longitudinal axis, and a latitudinal axis. The shape of left cylindrical hinge 30 is similar to the inside of a hollow cylinder that has been cut longitudinally and then placed on the fishing lure with the concave surface facing outward. The leading edge of left cylindrical hinge 30 is adjacent to the front end of fishing lure with hydrofoil flares, cylindrical hinges, and hook cavity 1. The trailing edge of left cylindrical hinge 30 is adjacent to the rear end of fishing lure with hydrofoil flares, cylindrical hinges, and hook cavity 1. Left cylindrical hinge 30 is adjacent to left hydrofoil flare 10 on the rearward end of left hydrofoil flare 10. The longitudinal axis of left cylindrical hinge 30 is perpendicular to the longitudinal axis of fishing lure with hydrofoil flares, cylindrical hinges, and hook cavity 1. The latitudinal axis of left cylindrical hinge 30 is parallel with the longitudinal axis of fishing lure with hydrofoil flares, cylindrical hinges, and hook cavity 1. As stated, left cylindrical hinge 30 is a partial cylindrical shape and thus is not a full cylinder with a full 360 degree circular cross-section. The cross-section of left cylindrical hinge 30 ranges from one-quarter of a circle to one-half of a circle. The portion of a full cylinder between the leading edge and trailing edge of left cylindrical hinge 30 is about one-quarter of a circle to one-half of a circle or about 90-180 degrees. Thus, the 90 degree embodiment of left cylindrical hinge 30 represents one quarter of a complete cylindrical shape and the 180 degree embodiment of left cylindrical hinge 30 represents one half of a complete cylindrical shape. The angle between the leading edge radius and trailing edge radius of left cylindrical hinge 30 can be any angle between 90-180 degrees inclusive. Together with left hydrofoil flare 10, right hydrofoil flare 20, and right cylindrical hinge 40, the left cylindrical hinge 30 helps cause fishing lure with hydrofoil flares, cylindrical hinges, and hook cavity 1 to look like a real fishing swimming in the water. The 90 degree embodiment of left cylindrical hinge 30 causes less swimming action and less bending of the fishing lure than the 180 degree embodiment of left cylindrical hinge 30. Likewise, a 120 degree embodiment of left cylindrical hinge 30 causes less swimming action and less bending of the fishing lure than the 160 degree embodiment of left cylindrical hinge 30. Fishing lure with hydrofoil flares, cylindrical hinges, and hook cavity 1 may be made to provide more or less swimming and bending action to suit a particular application or mimic a particular type of bait fish. In best mode, of left cylindrical hinge 30 is integral with fishing lure with hydrofoil flares, cylindrical hinges, and hook cavity 1 and is molded in the same piece of material as fishing lure with hydrofoil flares, cylindrical hinges, and hook cavity 1.

Right cylindrical hinge 40 is a cylindrical concave area in the exterior surface of fishing lure with hydrofoil flares, cylindrical hinges, and hook cavity 1 on the right side and middle section of fishing lure with hydrofoil flares, cylindrical hinges, and hook cavity 1 as depicted. Right cylindrical hinge 40 is a partial cylindrical shape. Right cylindrical hinge 40 has a radius, a width, a length, an upper edge, a lower edge, a leading edge, a trailing edge, a longitudinal axis, and a latitudinal axis. The shape of right cylindrical hinge 40 is similar to the inside of a hollow cylinder that has been cut longitudinally and then placed on the fishing lure with the concave surface facing outward. The leading edge of right cylindrical hinge 40 is adjacent to the front end of fishing lure with hydrofoil flares, cylindrical hinges, and hook cavity 1. The trailing edge of right cylindrical hinge 40 is adjacent to the rear end of fishing lure with hydrofoil flares, cylindrical hinges, and hook cavity 1. Right cylindrical hinge 40 is adjacent to right hydrofoil flare 20 on the rearward end of right hydrofoil flare 20. The longitudinal axis of right cylindrical hinge 40 is perpendicular to the longitudinal axis of fishing lure with hydrofoil flares, cylindrical hinges, and hook cavity 1. The latitudinal axis of right cylindrical hinge 40 is parallel with the longitudinal axis of fishing lure with hydrofoil flares, cylindrical hinges, and hook cavity 1. As stated, right cylindrical hinge 40 is a partial cylindrical shape and thus is not a full cylinder with a full 360 degree circular cross-section. The cross-section of right cylindrical hinge 40 ranges from one-quarter of a circle to one-half of a circle. The portion of a full cylinder between the leading edge and trailing edge of right cylindrical hinge 40 is about one-quarter of a circle to one-half of a circle or about 90-180 degrees. Thus, the 90 degree embodiment of right cylindrical hinge 40 represents one quarter of a complete cylindrical shape and the 180 degree embodiment of right cylindrical hinge 40 represents one half of a complete cylindrical shape. The angle between the leading edge radius and the trailing edge radius of right cylindrical hinge 40 can be any angle between 90-180 degrees inclusive. Together with left hydrofoil flare 10, right hydrofoil flare 20, and left cylindrical hinge 30, the right cylindrical hinge 40 helps cause fishing lure with hydrofoil flares, cylindrical hinges, and hook cavity 1 to look like a real fishing swimming in the water. The 90 degree embodiment of right cylindrical hinge 40 causes less swimming action and less bending of the fishing lure than the 180 degree embodiment of right cylindrical hinge 40. Likewise, a 120 degree embodiment of right cylindrical hinge 40 causes less swimming action and less bending of the fishing lure than the 160 degree embodiment of right cylindrical hinge 40. Fishing lure with hydrofoil flares, cylindrical hinges, and hook cavity 1 may be made to provide more or less swimming and bending action to suit a particular application or mimic a particular type of bait fish. In best mode, of right cylindrical hinge 40 is integral with fishing lure with hydrofoil flares, cylindrical hinges, and hook cavity 1 and is molded in the same piece of material as fishing lure with hydrofoil flares, cylindrical hinges, and hook cavity 1.

Fishing lure with hydrofoil flares, cylindrical hinges, and hook cavity 1 comprises: a hook cavity 50. Hook cavity 50 is used to hold and retain a fishing hook 100 inside fishing lure with hydrofoil flares, cylindrical hinges, and hook cavity 1. Fishing lure with hydrofoil flares, cylindrical hinges, and hook cavity 1 requires a fishing hook 100 in order to properly function and catch fish. Fisherman can use any known type of fishing hook 100 with fishing lure with hydrofoil flares, cylindrical hinges, and hook cavity 1. A fishing hook 100 is not a claimed element of this invention.

Hook cavity 50 is a cavity, pocket, pouch, or gap in the front section of fishing lure with hydrofoil flares, cylindrical hinges, and hook cavity 1. Hook cavity 50 is located in between the nose of fishing lure with hydrofoil flares, cylindrical hinges, and hook cavity 1 and the left and right cylindrical hinges of fishing lure with hydrofoil flares, cylindrical hinges, and hook cavity 1. Hook cavity 50 represents a large portion of the nose of fishing lure with hydrofoil flares, cylindrical hinges, and hook cavity 1. Hook cavity 50 has a length, a width, a thickness, a front wall, a rear wall, an upper wall, a lower wall, a left wall, and a right wall. Each wall of hook cavity is in the interior of fishing lure with hydrofoil flares, cylindrical hinges, and hook cavity 1. The front wall of hook cavity 50 is contiguous with the nose of fishing lure with hydrofoil flares, cylindrical hinges, and hook cavity 1. The rear wall of hook cavity 50 is contiguous with the middle section of fishing lure with hydrofoil flares, cylindrical hinges, and hook cavity 1. The length of hook cavity 50 is equivalent to the length of a fishing hook 100. The width of hook cavity 50 is equivalent to the width of a fishing hook 100.

Hook cavity 50 has a hook exposure port 52. Hook exposure port 52 is an open area or void in the upper edge of the front section of fishing lure with hydrofoil flares, cylindrical hinges, and hook cavity 1 that breaks through or passes through into the hook cavity 50 as depicted. Hook exposure port 52 is an open area or void in the upper wall of hook cavity 50. Hook exposure port 52 functions to provide clearance or an opening in hook cavity 50 for the fishing hook 100 and the barbed point 101 of the hook 100. When a real fish (not depicted) bites fishing lure with hydrofoil flares, cylindrical hinges, and hook cavity 1 the fishing hook 100 and barbed point 101 of the fishing hook 10 must attach to the real fish in order for the fisherman to reel in the real fish and to catch the real fish which is whole point of fishing. Hook exposure port 52 provides clearance for the fishing hook 100 to contact the real fish and latch onto the real fish. Hook exposure port 52 has a length that is slightly smaller than the length of fishing hook 100.

Hook cavity 50 has a hook cavity drain port 54. Hook cavity drain port 54 is an open area or void in the lower edge of the front section of fishing lure with hydrofoil flares, cylindrical hinges, and hook cavity 1 that breaks through or passes through into the hook cavity 50 as depicted. Hook cavity drain port 54 is an open area or void in the lower wall of hook cavity 50. Hook cavity drain port 54 is much smaller than hook exposure port 52 as depicted. Hook cavity drain port 54 functions to provide a drain or opening in the lower wall of hook cavity 50 for water or air bubbles to exit from the hook cavity 50. Applicant's experimentation has determined that this drain can sometimes be necessary for the proper functioning of the swimming effect of the fishing lure.

Hook cavity 50 has a hook puncture tab 56. Hook puncture tab 56 is a rectangular tab or tongue of material projecting from the rear wall of hook cavity 50. Hook puncture tab 56 has a length, a width, a thickness, a front edge, a rear edge, a left edge, an upper surface, a lower surface, a longitudinal axis, and a latitudinal axis. The rear edge of hook puncture tab 56 is integral with the rear wall of hook cavity 50. The right edge of hook puncture tab 56 is integral with the right wall of hook cavity 50. The left edge of hook puncture tab 56 is integral with the left wall of hook cavity 50. The front edge of hook puncture tab 56 is open and located inside hook cavity 50 as depicted. The longitudinal axis of hook puncture tab 56 is horizontal and parallel with the longitudinal axis of fishing lure with hydrofoil flares, cylindrical hinges, and hook cavity 1. Hook puncture tab 56 functions to help hold a secure fishing hook 100 within hook cavity 50 while the fishing lure is being used and traveling through the water.

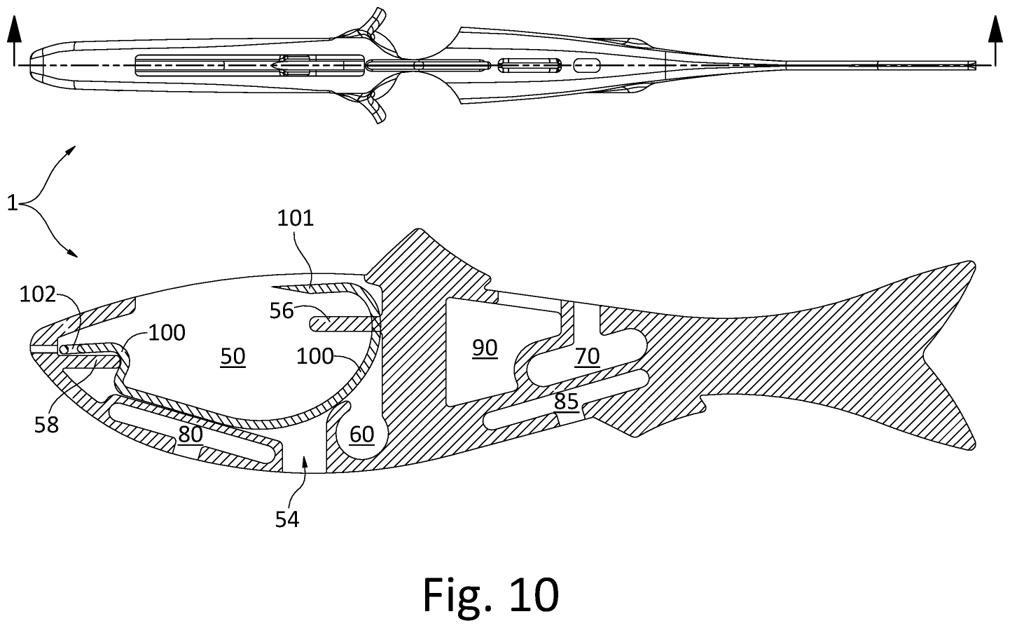

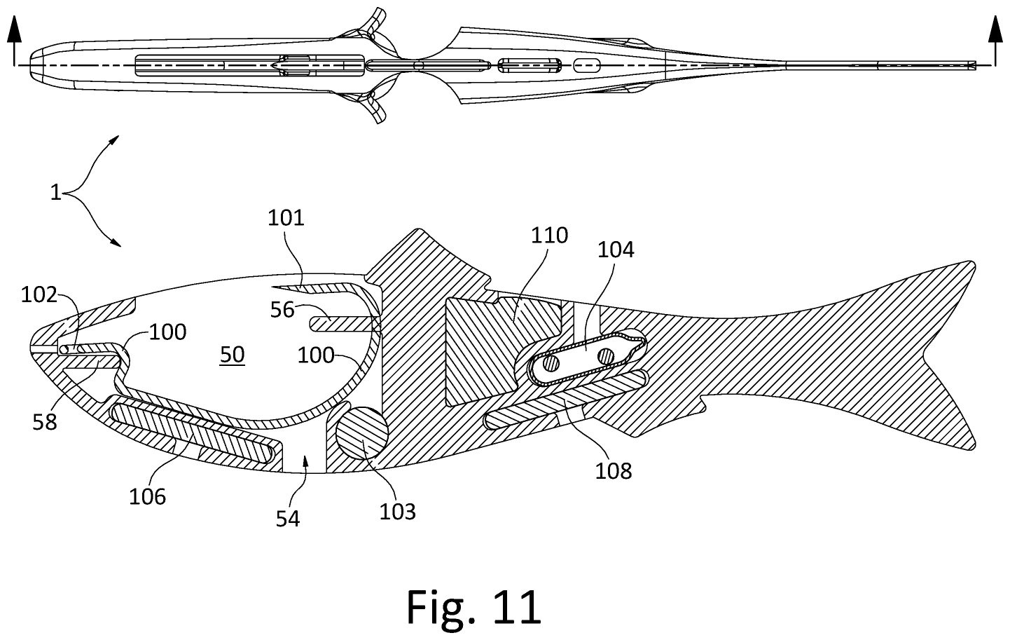

During installation of a fishing hook 100 into hook cavity 50, the barbed hook or sharp end of the fishing hook 100 is inserted through hook puncture tab 56 and curled around the hook puncture tab 56 to firmly secure and hold the fishing hook 100 inside of hook cavity 50, as depicted in FIGS. 10 and 11.

Hook cavity 50 has a hook stop tab 58. Hook stop tab 58 is a rectangular tab or tongue of material projecting from the front wall of hook cavity 50. Hook stop tab 58 has a length, a width, a thickness, a front edge, a rear edge, a left edge, an upper surface, a lower surface, a longitudinal axis, and a latitudinal axis. The front edge of hook stop tab 58 is integral with the front wall of hook cavity 50. The right edge of hook stop tab 58 is integral with the right wall of hook cavity 50. The left edge of hook stop tab 58 is integral with the left wall of hook cavity 50. The rear edge of hook stop tab 56 is open and located inside hook cavity 50 as depicted. The longitudinal axis of hook stop tab 58 is horizontal and parallel with the longitudinal axis of fishing lure with hydrofoil flares, cylindrical hinges, and hook cavity 1. Hook stop tab 56 functions to help hold a secure fishing hook 100 within hook cavity 50 while the fishing lure is being used and traveling through the water.

A fishing hook 100 is installed into fishing lure with hydrofoil flares, cylindrical hinges, and hook cavity 1 as follows. First, the barbed point 101 on fishing hook 100 is inserted through the nose 2 of fishing lure with hydrofoil flares, cylindrical hinges, and hook cavity 1 in order to pierce the front wall of hook cavity 50, just above the hook stop tab 58 and just below the upper wall of hook cavity 50. The sharp barbed point 101 on fishing hook 100 is used to penetrate the outer most point of the nose 2 of fishing lure with hydrofoil flares, cylindrical hinges, and hook cavity 1 to make a hole in the point of the nose 2 just above the hook stop tab 58. Then the fishing hook 100 is curled around or rotated and fed into the hook cavity 52 through this hole. Next, as the fishing hook 100 is being inserted into the hook cavity 50, the sharp barbed point 101 on the fishing hook 100 is guided to pierce the hook puncture tab 56. The barbed point 101 on fishing hook 100 is guided to pierce or puncture the lower surface of hook puncture tab 56 and then emerge out of the upper surface of hook puncture tab 56. Next, the fishing hook 100 is curled or rotated more to allow the eye 102 of fishing hook 100 to enter the hook cavity 50 and to nest or rest inside of hook cavity 50 just above hook stop tab 58. The eye 102 of fishing hook 100 rests on the upper surface of hook stop tab 58 as depicted. Thus, the hook puncture tab 56 is punctured by fishing hook 100 while the hook stop tab is not punctured by fishing hook 100. When properly installed, fishing hook 100 remains secure and held firmly in place within hook cavity 50 as depicted in FIGS. 10 and 11. Of course, the fishing hook 100 is attached to fishing line (not depicted) and the fishing line is attached to a fishing pole (not depicted).

Fishing lure with hydrofoil flares, cylindrical hinges, and hook cavity 1 may further comprise: a weight cavity 60. Weight cavity 60 is a cavity, pocket, pouch, or gap in the lower edge of the middle section of fishing lure with hydrofoil flares, cylindrical hinges, and hook cavity 1. In best mode, weight cavity 60 is spherical or a spherical cavity, pocket, pouch, or gap. Weight cavity 60 is used to hold a weight 103 inside fishing lure with hydrofoil flares, cylindrical hinges, and hook cavity 1. Many times, fisherman require the fishing lure to be weighted or have a weight on it to help force the fishing lure to the bottom of the water. Fisherman can use any known type of weight 103 with fishing lure with hydrofoil flares, cylindrical hinges, and hook cavity 1. A weight 103 is not a claimed element of this invention. Weight cavity 60 functions to reversibly receive and hold many different types of weights 103.

Weight cavity 60 has a weight insertion port 62. Weight cavity insertion port 62 is an open area or void in the lower wall of hook cavity 50 that breaks through or passes through into the weight cavity 60 as depicted. A weight 103 is installed or inserted into weight cavity 60 by sliding the weight 103 into the hook cavity 50 and into the weight insertion port 63 to place the weight 103 into weight cavity 60 as depicted in FIG. 11. A fishing hook 100 should not be inside of hook cavity 50 when installing or removing a weight 103 from weight cavity 60. Alternately, weight insertion port may be an open area or void in the lower wall of fishing lure with hydrofoil flares, cylindrical hinges, and hook cavity 1 that breaks through or passes through into the weight cavity 60 in embodiments without a hook cavity 50.

Fishing lure with hydrofoil flares, cylindrical hinges, and hook cavity 1 may further comprise: a rattle cavity 70. Rattle cavity 70 is a cavity, pocket, pouch, or gap in the middle section or tail section of fishing lure with hydrofoil flares, cylindrical hinges, and hook cavity 1. In best mode, rattle cavity 70 is cylindrical. Rattle cavity 70 is used to hold a rattle 104 inside fishing lure with hydrofoil flares, cylindrical hinges, and hook cavity 1. Many times, fisherman require the fishing lure to rattle or make sound in order to attract real fish. Fisherman can use any known type of rattle 104 with fishing lure with hydrofoil flares, cylindrical hinges, and hook cavity 1. A rattle 104 is not a claimed element of this invention. Rattle cavity 70 functions to reversibly receive and hold many different types of rattles 104.

Rattle cavity 70 has a rattle insertion port 72. Rattle insertion port 72 is an open area or void in the upper edge of fishing lure with hydrofoil flares, cylindrical hinges, and hook cavity 1 that breaks through or passes through into the rattle cavity 70 as depicted. A rattle 104 is installed or inserted into rattle cavity 70 by sliding the rattle 104 into rattle insertion port 72 to place the rattle 104 into rattle cavity 70 as depicted in FIG. 11.

Fishing lure with hydrofoil flares, cylindrical hinges, and hook cavity 1 may further comprise: a first glow stick cavity 80. First glow stick cavity 80 is a cavity, pocket, pouch, or gap in the lower edge of the front section of fishing lure with hydrofoil flares, cylindrical hinges, and hook cavity 1. In best mode, first glow stick cavity 80 is cylindrical. First glow stick cavity 80 is used to hold a first glow stick 106 inside fishing lure with hydrofoil flares, cylindrical hinges, and hook cavity 1. Many times, fisherman require the fishing lure to glow or give off light in order to attract real fish. Fisherman can use any known type of glow sticks with fishing lure with hydrofoil flares, cylindrical hinges, and hook cavity 1. First glow stick 106 is not a claimed element of this invention. First glow stick cavity 80 functions to reversibly receive and hold many different types of glow sticks 106.

First glow stick cavity 80 has a first glow stick insertion port 82. First glow stick insertion port 82 is an open area or void in the lower edge of fishing lure with hydrofoil flares, cylindrical hinges, and hook cavity 1 that breaks through or passes through into the first glow stick cavity 80 as depicted. A first glow stick 106 is installed or inserted into first glow stick cavity 80 by sliding the first glow stick 106 into first glow stick insertion port 82 to place the first glow stick 106 into first glow stick cavity 80 as depicted in FIG. 11.

Fishing lure with hydrofoil flares, cylindrical hinges, and hook cavity 1 may further comprise: a second glow stick cavity 85. Second glow stick cavity 85 is a cavity, pocket, pouch, or gap in the lower edge of the rear section of fishing lure with hydrofoil flares, cylindrical hinges, and hook cavity 1. In best mode, second glow stick cavity 85 is cylindrical. Second glow stick cavity 85 is used to hold a second glow stick 108 inside fishing lure with hydrofoil flares, cylindrical hinges, and hook cavity 1. Many times, fisherman require the fishing lure to glow or give off light in order to attract real fish. Fisherman can use any known type of glow sticks with fishing lure with hydrofoil flares, cylindrical hinges, and hook cavity 1. Second glow stick 108 is not a claimed element of this invention. Second glow stick cavity 85 functions to reversibly receive and hold many different types of glow sticks 108.

Second glow stick cavity 85 has a second glow stick insertion port 87. Second glow stick insertion port 87 is an open area or void in the lower edge of fishing lure with hydrofoil flares, cylindrical hinges, and hook cavity 1 that breaks through or passes through into the second glow stick cavity 85 as depicted. A second glow stick 108 is installed or inserted into second glow stick cavity 85 by sliding the second glow stick 108 into second glow stick insertion port 85 to place the second glow stick 108 into second glow stick cavity 85 as depicted in FIG. 11.

Fishing lure with hydrofoil flares, cylindrical hinges, and hook cavity 1 may further comprise: a scent cavity 90. Scent cavity 90 is a cavity, pocket, pouch, or gap in the upper edge of the middle section or tail section of fishing lure with hydrofoil flares, cylindrical hinges, and hook cavity 1. Scent cavity 90 is used to hold scent 110 inside fishing lure with hydrofoil flares, cylindrical hinges, and hook cavity 1. Many times, fisherman require the fishing lure to have an odor or give off an odor in order to attract real fish. Scent 90 can be a liquid, gel, or solid material. Scent 90 has a strong smell that emits this smell even under water and attracts fish. Fisherman can use any known type of scent 110 with fishing lure with hydrofoil flares, cylindrical hinges, and hook cavity 1. Scent 110 is not a claimed element of this invention. Scent cavity 90 functions to reversibly receive and hold many different types of scent 110.

Scent cavity 90 has a scent insertion port 92. Scent insertion port 92 is an open area or void in the upper edge of fishing lure with hydrofoil flares, cylindrical hinges, and hook cavity 1 that breaks through or passes through into the scent cavity 90 as depicted. An amount of scent 110 is installed or inserted into scent cavity 90 through scent insertion port 92 to load scent 110 into scent cavity 90 as depicted in FIG. 11.

In order to use fishing lure with hydrofoil flares, cylindrical hinges, and hook cavity 1, a fishing hook 100 is installed into fishing lure with hydrofoil flares, cylindrical hinges, and hook cavity 1 as described above. A weight 103, a rattle 104, a first glow stick 106, a second glow stick 108, and/or scent 110 may also be installed as desired as described above. Then the fisherman casts the fishing lure with hydrofoil flares, cylindrical hinges, and hook cavity 1 out into the water and reels in fishing lure with hydrofoil flares, cylindrical hinges, and hook cavity 1 to cause fishing lure with hydrofoil flares, cylindrical hinges, and hook cavity 1 to appear like a real fishing swimming through the water. This swimming action then attracts real fish which bite fishing lure with hydrofoil flares, cylindrical hinges, and hook cavity 1 wherein the real fish catches itself onto the barbed point 101 on the fishing hook 100. At this point, the fisherman may reel in the real fish and capture the real fish to accomplish a catch.

In the event that the fishing hook 100 is lost or damaged, the fisherman simply reinstalls a new fishing hook 100 into fishing lure with hydrofoil flares, cylindrical hinges, and hook cavity 1 and casts again. In the event that the fishing lure with hydrofoil flares, cylindrical hinges, and hook cavity 1 is lost or damaged, the fisherman simply used a new fishing lure with hydrofoil flares, cylindrical hinges, and hook cavity 1 and reinstalls a new fishing hook 100 and a new weight 103, a rattle 104, a first glow stick 106, a second glow stick 108, and/or scent 110 as desired and casts again. weight 103, a rattle 104, a first glow stick 106, a second glow stick 108, and/or scent 110 may also be installed as desired and casts again. Fishing lure with hydrofoil flares, cylindrical hinges, and hook cavity 1 is typically sold in a pack with multiple replacement fishing lures with hydrofoil flares, cylindrical hinges, and hook cavity 1.

What is claimed is:

1. A fishing lure comprising: a sheet of flexible material; a left hydrofoil flare; a right hydrofoil flare, a left cylindrical hinge, and a right cylindrical hinge, wherein,
said sheet of flexible material has a left side, a right side, an upper edge, a lower edge, a front end, a rear end, a front section, a middle section, a tail section, a length, a width, an exterior surface, an interior, a longitudinal axis, and a latitudinal axis,
said sheet of flexible material has a nose, a left eye, a right eye, a dorsal fin, an anal fin, and a tail fin,
said nose is an oblong, rounded, projected member on said front end of said sheet of flexible material,
said left eye is a circular concave or convex area on said exterior surface of said sheet of flexible material located on said left side and said front section of said sheet of flexible material,
said right eye is a circular concave or convex area on said exterior surface of said sheet of flexible material located on said right side and said front section of said sheet of flexible material,
said dorsal fin is a triangular shaped tab or appendage projecting upward from said exterior surface of said sheet of flexible material located on said upper edge and said middle section of said sheet of flexible material,
said anal fin is a triangular or quadrilateral shaped tab or appendage projection downward from said exterior surface of said sheet of flexible material located on said lower edge and said tail section of said sheet of flexible material,
said tail fin is an arrowhead shaped or arrow shaped tab or appendage on said rear end of said sheet of flexible material,
said left hydrofoil flare is a flexible vertical half-circle shaped or half-moon shaped tab or appendage projecting outward and rearward from said exterior surface of said sheet of flexible material,
said left hydrofoil is located on said left side and said middle section of said sheet of flexible material,
said left hydrofoil is located between said left eye and said dorsal fin of said sheet of flexible material,
said left hydrofoil has a circular edge, a straight edge, a longitudinal axis, and a latitudinal axis,
said straight edge of said left hydrofoil flare is attached to said exterior surface of said left side of said sheet of flexible material,
said circular edge of said left hydrofoil flare is opposite said straight edge of said left hydrofoil flare,
said straight edge of said left hydrofoil is parallel with said longitudinal axis of said left hydrofoil flare,
said latitudinal axis of said left hydrofoil flare is perpendicular to said longitudinal axis of said left hydrofoil flare,
said longitudinal axis of said left hydrofoil flare is perpendicular to said longitudinal axis of said sheet of flexible material,
said latitudinal axis of said left hydrofoil flare projects rearwards at an angle between 20-60 degrees from said longitudinal axis of said sheet of flexible material,
said right hydrofoil flare is a flexible vertical half-circle shaped or half-moon shaped tab or appendage projecting outward and rearward from said exterior surface of said sheet of flexible material,
said right hydrofoil is located on said right side and said middle section of said sheet of flexible material,
said right hydrofoil is located between said right eye and said dorsal fin of said sheet of flexible material,
said right hydrofoil has a circular edge, a straight edge, a longitudinal axis, and a latitudinal axis,
said straight edge of said right hydrofoil flare is attached to said exterior surface of said right side of said sheet of flexible material,
said circular edge of said right hydrofoil flare is opposite said straight edge of said right hydrofoil flare,
said straight edge of said right hydrofoil is parallel with said longitudinal axis of said right hydrofoil flare,
said latitudinal axis of said right hydrofoil flare is perpendicular to said longitudinal axis of said right hydrofoil flare,
said longitudinal axis of said right hydrofoil flare is perpendicular to said longitudinal axis of said sheet of flexible material,
said latitudinal axis of said right hydrofoil flare projects rearwards at an angle between 20-60 degrees from said longitudinal axis of said sheet of flexible material,
said left cylindrical hinge is a cylindrical concave area in said exterior surface of said left side of said sheet of flexible material,
said left cylindrical hinge is a partial cylindrical shape with a radius, a width, a length, an upper edge, a lower edge, a leading edge, a trailing edge, a longitudinal axis, and a latitudinal axis,
said longitudinal axis of said left cylindrical hinge is perpendicular to said longitudinal axis of said sheet of flexible material,
said latitudinal axis of said left cylindrical hinge is parallel with said longitudinal axis of said sheet of flexible material,
said radius of said left cylindrical hinge at said leading edge forms an angle with said radius of said left cylindrical hinge at said trailing edge that measures between 90-180 degrees inclusive,
said right cylindrical hinge is a cylindrical concave area in said exterior surface of said right side of said sheet of flexible material,
said right cylindrical hinge is a partial cylindrical shape with a radius, a width, a length, an upper edge, a lower edge, a leading edge, a trailing edge, a longitudinal axis, and a latitudinal axis,
said longitudinal axis of said right cylindrical hinge is perpendicular to said longitudinal axis of said sheet of flexible material,
said latitudinal axis of said right cylindrical hinge is parallel with said longitudinal axis of said sheet of flexible material, and
said radius of said right cylindrical hinge at said leading edge forms an angle with said radius of said right cylindrical hinge at said trailing edge that measures between 90-180 degrees inclusive.

2. A fishing lure as recited in claim 1 further comprising: a rattle cavity, wherein,
said rattle cavity is a cavity, pocket, pouch, or gap in said middle section or said tail section of said sheet of flexible material,
said rattle cavity further comprises a rattle insertion port, wherein said rattle insertion port is an open area or void in said upper edge of said sheet of flexible material that breaks through or passes through into said rattle cavity, and
said rattle cavity functions to reversibly receive and hold a rattle.

3. A fishing lure as recited in claim 1 further comprising: a scent cavity, wherein
said scent cavity is a cavity, pocket, pouch, or gap in said middle section or said tail section of said sheet of flexible material,
said scent stick cavity further comprises a scent stick insertion port, wherein said scent cavity insertion port is an open area or void in said upper edge of said sheet of flexible material that breaks through or passes through into said scent cavity, and
said scent cavity functions to reversibly receive and hold a scent in liquid, gel, or solid form.

4. A fishing lure comprising: a sheet of flexible material; a hook cavity; a hook exposure port, a hook cavity drain port, a hook puncture tab, and a hook stop tab, wherein,
said sheet of flexible material has a left side, a right side, an upper edge, a lower edge, a front end, a rear end, a front section, a middle section, a tail section, a length, a width, an exterior surface, an interior, a longitudinal axis, and a latitudinal axis,
said sheet of flexible material has a nose, a left eye, a right eye, a dorsal fin, an anal fin, and a tail fin,
said nose is an oblong, rounded, projected member on said front end of said sheet of flexible material,
said left eye is a circular concave or convex area on said exterior surface of said sheet of flexible material located on said left side and said front section of said sheet of flexible material,
said right eye is a circular concave or convex area on said exterior surface of said sheet of flexible material located on said right side and said front section of said sheet of flexible material,
said dorsal fin is a triangular shaped tab or appendage projecting upward from said exterior surface of said sheet of flexible material located on said upper edge and said middle section of said sheet of flexible material,
said anal fin is a triangular or quadrilateral shaped tab or appendage projection downward from said exterior surface of said sheet of flexible material located on said lower edge and said tail section of said sheet of flexible material,
said tail fin is an arrowhead shaped or arrow shaped tab or appendage on said rear end of said sheet of flexible material,
said hook cavity is a cavity, pocket, pouch, or gap in said front section of said sheet of flexible material,
said hook cavity has a length, a width, a thickness, a front wall, a rear wall, an upper wall, a lower wall, a left wall, and a right wall,
said hook exposure port is an open area or void in said upper edge of said sheet of flexible material at said front end of said sheet of flexible material that breaks through or passes through into said hook cavity,
said hook exposure port is an open area or void in said upper wall of said hook cavity,
said hook cavity drain port is an open area or void in said lower edge of said sheet of flexible material at said front section of said sheet of flexible material that breaks through or passes through into said hook cavity,
said hook cavity drain port is an open area or void in said lower wall of said hook cavity,
said hook puncture tab is a rectangular tab or tongue of material projecting from said rear wall of said hook cavity,
said hook puncture tab has a length, a width, a thickness, a front edge, a rear edge, a left edge, an upper surface, a lower surface, a longitudinal axis, and a latitudinal axis,
said rear edge of said hook puncture tab is integral with said rear wall of said hook cavity,
said right edge of said hook puncture tab is integral with said right wall of said hook cavity,
said left edge of said hook puncture tab is integral with said left wall of said hook cavity,
said longitudinal axis of said hook puncture tab is horizontal and parallel with said longitudinal axis of said sheet of flexible material,
said hook stop tab is a rectangular tab or tongue of material projecting from said front wall of said hook cavity,
said hook stop tab has a length, a width, a thickness, a front edge, a rear edge, a left edge, an upper surface, a lower surface, a longitudinal axis, and a latitudinal axis,
said front edge of said hook stop tab is integral with said front wall of said hook cavity,
said right edge of said hook stop tab is integral with said right wall of said hook cavity,
said left edge of said hook stop tab is integral with said left wall of said hook cavity, and
said longitudinal axis of said hook stop tab is horizontal and parallel with said longitudinal axis of said sheet of flexible material.

5. A fishing lure as recited in claim 4 further comprising: a rattle cavity, wherein,
said rattle cavity is a cavity, pocket, pouch, or gap in said middle section or said tail section of said sheet of flexible material,
said rattle cavity further comprises a rattle insertion port, wherein said rattle insertion port is an open area or void in said upper edge of said sheet of flexible material that breaks through or passes through into said rattle cavity, and
said rattle cavity functions to reversibly receive and hold a rattle.

6. A fishing lure as recited in claim 4 further comprising: a scent cavity, wherein
said scent cavity is a cavity, pocket, pouch, or gap in said middle section or said tail section of said sheet of flexible material,
said scent stick cavity further comprises a scent stick insertion port, wherein said scent cavity insertion port is an open area or void in said upper edge of said sheet of flexible material that breaks through or passes through into said scent cavity, and
said scent cavity functions to reversibly receive and hold a scent in liquid, gel, or solid form.

7. A fishing lure comprising: a sheet of flexible material; a weight cavity; a rattle cavity; a scent cavity, and a glow stick cavity, wherein
said sheet of flexible material has a left side, a right side, an upper edge, a lower edge, a front end, a rear end, a front section, a middle section, a tail section, a length, a width, an exterior surface, an interior, a longitudinal axis, and a latitudinal axis,
said sheet of flexible material has a nose, a left eye, a right eye, a dorsal fin, an anal fin, and a tail fin,
said nose is an oblong, rounded, projected member on said front end of said sheet of flexible material,
said left eye is a circular concave or convex area on said exterior surface of said sheet of flexible material located on said left side and said front section of said sheet of flexible material,
said right eye is a circular concave or convex area on said exterior surface of said sheet of flexible material located on said right side and said front section of said sheet of flexible material,
said dorsal fin is a triangular shaped tab or appendage projecting upward from said exterior surface of said sheet of flexible material located on said upper edge and said middle section of said sheet of flexible material,
said anal fin is a triangular or quadrilateral shaped tab or appendage projection downward from said exterior surface of said sheet of flexible material located on said lower edge and said tail section of said sheet of flexible material,
said tail fin is an arrowhead shaped or arrow shaped tab or appendage on said rear end of said sheet of flexible material,
said weight cavity is a cavity, pocket, pouch, or gap in said middle section of said sheet of flexible material,
said weight cavity further comprises a weight insertion port 62, wherein said weight cavity insertion port is an open area or void in said lower wall of said sheet of flexible material that breaks through or passes through into said weight cavity,
said weight cavity functions to reversibly receive and hold a weight,
said rattle cavity is a cavity, pocket, pouch, or gap in said middle section or said tail section of said sheet of flexible material,
said rattle cavity further comprises a rattle insertion port, wherein said rattle insertion port is an open area or void in said upper edge of said sheet of flexible material that breaks through or passes through into said rattle cavity,
said rattle cavity functions to reversibly receive and hold a rattle,
said scent cavity is a cavity, pocket, pouch, or gap in said middle section or said tail section of said sheet of flexible material,
said scent stick cavity further comprises a scent stick insertion port, wherein said scent cavity insertion port is an open area or void in said upper edge of said sheet of flexible material that breaks through or passes through into said scent cavity,
said scent cavity functions to reversibly receive and hold a scent in liquid, gel, or solid form,
said glow stick cavity is a cavity, pocket, pouch, or gap in said lower edge of said sheet of flexible material,
said glow stick cavity further comprises a glow stick insertion port, wherein said glow stick insertion port is an open area or void in said lower edge of said sheet of flexible material that breaks through or passes through into said glow stick cavity, and
said glow stick cavity functions to reversibly receive and hold a glow stick.
